(19) United States
(12) Patent Application Publication
(10) Pub. No.: US 2024/0085770 A1
(43) Pub. Date: Mar. 14, 2024

(54) PROJECTION DEVICE AND OPERATION METHOD OF PROJECTION DEVICE

(71) Applicant: Coretronic Projection (Kunshan) Corporation, Jiangsu (CN)

(72) Inventors: YEBING ZHANG, Jiangsu (CN); YIFEI SUN, Jiangsu (CN)

(73) Assignee: Coretronic Projection (Kunshan) Corporation, Jiangsu (CN)

(21) Appl. No.: 18/461,537

(22) Filed: Sep. 6, 2023

(30) Foreign Application Priority Data
Sep. 14, 2022 (CN) 202211113749.8

(51) Int. Cl. G03B 21/20; H04N 9/31

(52) U.S. Cl. CPC G03B 21/2033; H04N 9/3194; H04N 9/3197

(57) ABSTRACT

A projection device and an operation method of the projection device are provided. The projection device includes a driver, a LED module, a current sensor, and a controller. The driver generates a driving current signal according to a control signal. The LED module provides an output light beam in response to the driving current signal. The current sensor senses a driving current flowing through the LED module to generate a sensing signal. The controller generates the control signal according to a current calibration parameter and a first control parameter, and determines whether a current value of the driving current flowing through the LED module is in a target driving current value range. When the current value of the driving current is not in the target drive current value range, the controller changes the first control parameter to adjust the control signal.

### CROSS-REFERENCE TO RELATED APPLICATION

This application claims the priority benefit of China application serial no. 202211113749.8, filed on Sep. 14, 2022. The entirety of the above-mentioned patent application is hereby incorporated by reference herein and made a part of this specification.

### BACKGROUND

### Technical Field

The disclosure relates to an electronic device and an operation method of the electronic device, and more particularly, to a projection device and an operation method of the projection device.

### Description of Related Art

A projection device has a LED module. The LED module is configured to provide an output light beam (an illumination light beam) for projection. An existing calibration method of the LED module is to use a variable current limiting resistor disposed in the projection device to set a driving current flowing through the LED module. A resistance value of the current limiting resistor is changed to determine a current value of the driving current. Therefore, the LED module provides the output light beam based on the current value of the driving current. In addition, an external apparatus is used to detect the current value of the driving current flowing through the current limiting resistor and the LED module, and determine whether to adjust the resistance value of the current limiting resistor according to the current value of the driving current.

However, the above calibration method requires the use of the external apparatus to detect the current value of the driving current and adjust the resistance value of the current limiting resistor. Such a calibration method may increase the equipment cost. In addition, accuracy of the resistance value of the current limiting resistor is not stable after adjustment. Therefore, accuracy of such a calibration method may be limited by the current limiting resistor. How to provide an operation method for optimizing and calibrating the LED module is one of the research focuses for those skilled in the art.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a projection device and an operation method of the projection device, which may perform high-precision calibration on operation of an LED module of the projection device.

Other objectives and advantages of the disclosure may be further understood from the technical features disclosed herein.

In order to achieve one, a part, or all of the above objectives or other objectives, an embodiment of the disclosure provides a projection device. The projection device includes a driver, a LED module, a current sensor, and a controller. The driver generates a driving current signal according to a control signal. The LED module is coupled to the driver. The LED module provides an output light beam in a target brightness value range in response to the driving current signal. The target brightness value range corresponds to a target driving current value range of the driving current signal. The current sensor is coupled to the LED module. The current sensor senses a driving current flowing through the LED module to generate a sensing signal. The controller is coupled to the current sensor and the driver. The controller provides a current calibration parameter and a first control parameter, generates the control signal according to the current calibration parameter and the first control parameter, and determines whether a current value of the driving current flowing through the LED module is in the target driving current value range according to the sensing signal. When the current value of the driving current is not in the target driving current value range, the controller changes the first control parameter to adjust the control signal.

In order to achieve one, a part, or all of the above objectives or other objectives, an embodiment of the disclosure provides an operation method of a projection device. The projection device includes a driver and an LED module. The operation method includes the following. A current calibration parameter and a first control parameter are provided, and a control signal is generated according to the current calibration parameter and the first control parameter. A driving current signal is generated by the driver according to the control signal, so that the LED module provides an output light beam in a target brightness value range in response to the driving current signal. The target brightness value range corresponds to a target driving current value range of the driving current signal. A driving current flowing through the LED module is sensed to generate a sensing signal. It is determined whether a current value of the driving current flowing through the LED module is in the target driving current value range according to the sensing signal. When the current value of the driving current is not in the target driving current value range, the first control parameter is changed to adjust the control signal.

Based on the above, the embodiments of the disclosure have at least one of the following advantages or effects. When the current value of the driving current is not in the target driving current value range, the projection device changes the first control parameter to adjust the control signal. Different from the existing calibration method, in the disclosure, the first control parameter is used to adjust the control signal instead of adjusting the resistance value of the current limiting resistor. In this way, in the projection device and the operation method of the disclosure, the high-precision calibration is performed on the operation of the LED module of the projection device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a projection device according to the first embodiment of the disclosure.

FIG. 2 is a flowchart of an operation method according to FIG. 1.

FIG. 3 is a flowchart of another operation method according to FIG. 1.

FIG. 4 is a schematic view of a projection device according to the second embodiment of the disclosure.

FIG. 5 is a schematic view of a projection device according to the third embodiment of the disclosure.

FIG. 6 is a flowchart of an operation method according to FIG. 5.

FIG. 7 is a flowchart according to step S370.

FIG. 8 is another flowchart according to step S370.

FIG. 9 is a schematic view of a LED module and a current sensor according to an embodiment of the disclosure.

FIG. 10 is a tendency chart of a current value of a driving current according to an embodiment of the disclosure.

### DETAILED DESCRIPTION OF DISCLOSED EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

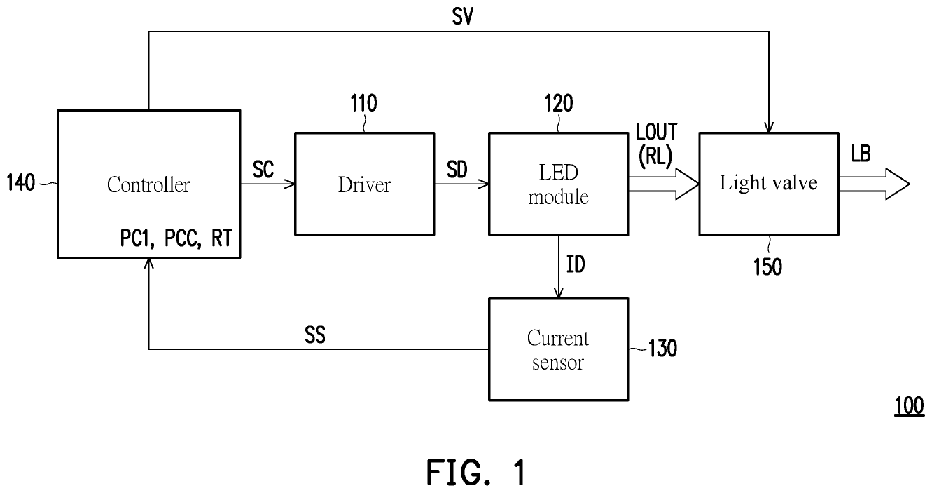

Referring to FIG. 1, FIG. 1 is a schematic view of a projection device according to the first embodiment of the disclosure. In this embodiment, a projection device 100 includes a driver 110, an LED module 120, a current sensor 130, and a controller 140. The driver 110 generates a driving current signal SD according to a control signal SC. The control signal SC is a pulse width modulation (PWM) signal. The driver 110 generates the driving current signal SD according to a duty cycle of the control signal SC, for example. For example, the driver 110 may generate (adjust) the driving current signal SD only according to the control signal SC without adjusting a resistance value of a current limiting resistor. The LED module 120 is coupled to the driver 110. The LED module 120 provides an output light beam LOUT in response to the driving current signal SD. In this embodiment, the LED module 120 provides the output light beam LOUT based on the driving current signal SD. A brightness of the output light beam LOUT is in a target brightness value range RL. The target brightness value range RL corresponds to a target driving current value range RT of the driving current signal SD. In this embodiment, the LED module 120 is, for example, implemented by at least one laser diode (the disclosure is not limited thereto). The current sensor 130 is coupled to the LED module 120. The current sensor 130 senses a driving current ID flowing through the LED module 120 to generate a sensing signal SS. Therefore, the sensing signal SS generated by the current sensor 130 is associated with a current value of the driving current ID. The sensing signal SS may be an analog voltage signal or a digital signal.

In this embodiment, the controller 140 is coupled to the current sensor 130 and the driver 110. The projection device 100 provides a current calibration parameter PCC and a first control parameter PC1. The controller 140 is configured to generate the control signal SC according to the current calibration parameter PCC and the first control parameter PC1. The controller 140 obtains the current value of the driving current ID according to the sensing signal SS, and determines whether the current value of the driving current ID flowing through the LED module 120 is in the target driving current value range RT. The target driving current value range RT has a maximum value and a minimum value, for example. When the current value of the driving current ID is determined to be not in the target driving current value range RT, the controller 140 changes the first control parameter PC1 to adjust the control signal SC, so that the current value of the driving current ID is controlled in the target driving current value range RT. On the other hand, when the current value of the driving current ID is determined to be in the target driving current value range RT, the controller 140 does not change (maintain) the first control parameter PC1. In particular, a maximum value of the first control parameter PC1 is, for example, “1023”, and when the projection device 100 is enabled, the controller 140 may provide a value (for example, “1010”) of the first control parameter PC1 according to brightness requirements. It should be noted that when the current value of the driving current ID is not in the target driving current value range RT, the controller 140 uses the first control parameter PC1 to adjust the control signal SC, so that the current value of the driving current ID is controlled in the target driving current value range RT. In this embodiment, the resistance value of the current limiting resistor is not adjusted. Therefore, calibration accuracy in this embodiment is not limited by the current limiting resistor. In this way, the projection device 100 may perform high-precision calibration on operation of the LED module 120. In addition, the above calibration is performed by the projection device 100 itself, and no external apparatus is required. In this way, calibration cost in this embodiment may be reduced.

In this embodiment, the driver 110 may be a driving circuit for driving the LED module 120. The controller 140 is, for example, a central processing unit (CPU), other programmable general-purpose or special-purpose microprocessors, a digital signal processor (DSP), a programmable controller, an application specific integrated circuit (ASIC), a programmable logic device (PLD), other similar devices, or a combination of the devices, which may load and execute computer programs.

In this embodiment, the projection device 100 further includes a light valve 150. The light valve 150 is coupled to the controller 140. The controller 140 controls the light valve 150 to convert the output light beam LOUT to generate an image light beam LB. The controller 140 uses a light valve control signal SV to control the light valve 150. The light valve 150 may be, for example, a reflective or transmissive spatial light modulator, such as, taking the reflective spatial light modulator as an example, a reflective liquid crystal on silicon (LCOS) or a digital micro-mirror element (DMD), and may include required light splitting, light combining, or light transmission elements. Further, the controller 140 enables the LED module 120 to generate the output light beam LOUT (for example, white light, or may be divided into light outputs of different colors in sequence), which is a highest brightness (or referred to as a brightest full-white frame) of the image light beam LB that may be generated by the projection device 100, and the light valve 150 may modulate the brightness of the image light beam LB to generate the image light beam LB according to the brightness of different colors and different pixels in an image frame.

In this embodiment, during normal use, the controller 140 samples the sensing signal SS based on a sampling cycle. Therefore, the controller 140 determines whether the current value of the driving current ID flowing through the LED module 120 is in the target driving current value range RT during the normal use, and adjusts the control signal SC accordingly.

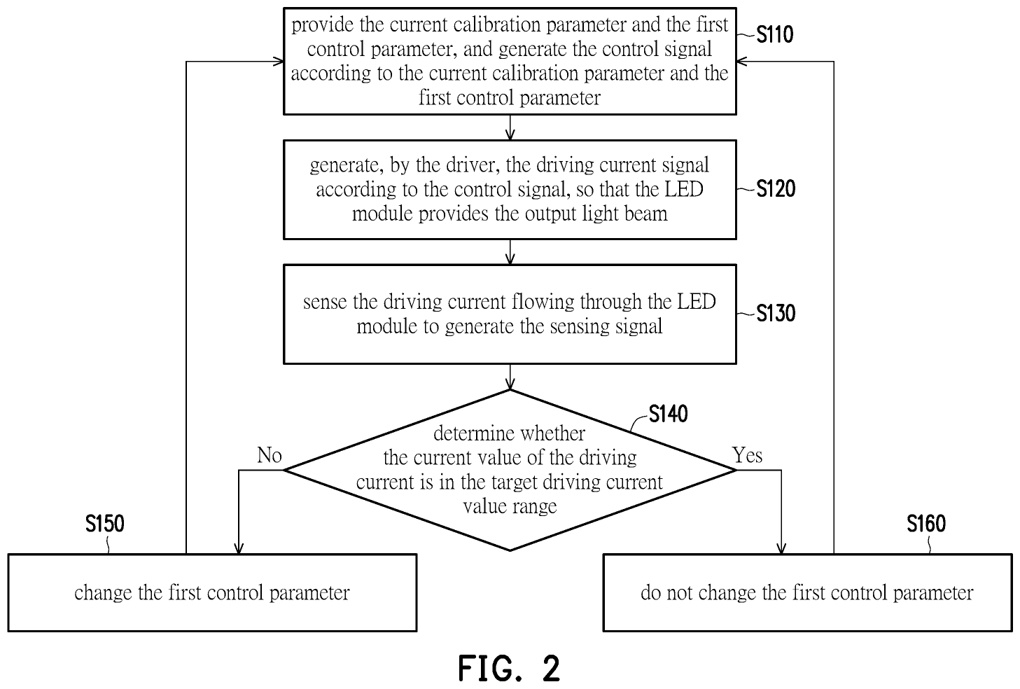

Referring to both FIGS. 1 and 2, FIG. 2 is a flowchart of an operation method according to FIG. 1. The operation method in FIG. 2 is applicable to the projection device 100. In step S110, the projection device 100 provides the current calibration parameter PCC and the first control parameter PC1, and generates the control signal SC according to the current calibration parameter PCC and the first control parameter PC1. In step S120, the driver 110 generates the driving current signal SD according to the control signal SC. Therefore, the LED module 120 provides the output light beam LOUT in response to the driving current signal SD. In step S130, the current sensor 130 senses the driving current ID flowing through the LED module 120 to generate the sensing signal SS. In step S140, the controller 140 determines whether the current value of the driving current ID flowing through the LED module 120 is in the target driving current value range RT according to the sensing signal SS. When the current value of the driving current ID is determined to be not in the target driving current value range RT, the controller 140 changes the first control parameter PC1 in step S150, and performs step S110 with the changed first control parameter PC1. Therefore, the control signal SC is adjusted.

On the other hand, when the current value of the driving current ID is determined to be in the target driving current value range RT, the controller 140 does not change the first control parameter PC1 in step S160, and still performs step S110 again with the first control parameter PC1. Therefore, the control signal SC is not adjusted. In other embodiments, after step S160 is completed, step S120 or step S130 may be performed directly, and the original control signal SC may be used to enable the LED module 120 to provide the output light beam LOUT without generating the control signal again.

Implementation details of steps S110 to S160 have been fully described in the embodiment of FIG. 1. Therefore, the same details will not be repeated in the following. In particular, the sensing of the driving current ID and the timing of performing the method shown in FIG. 2 are, for example, when the projection device 100 is enabled, continuously, or at intervals, and the disclosure is not limited thereto.

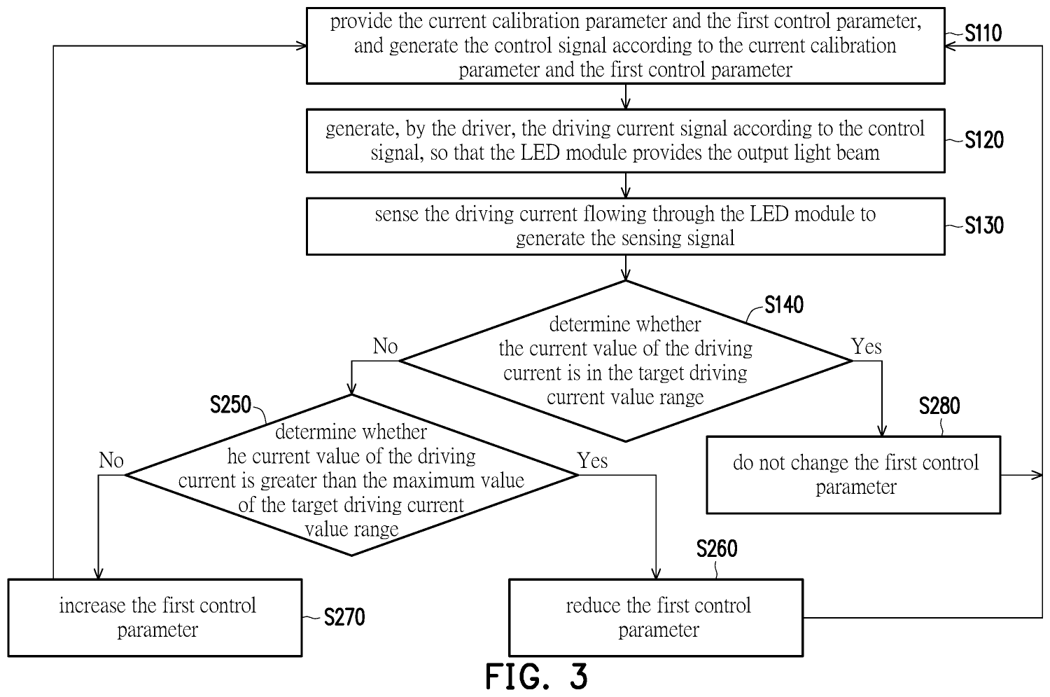

Referring to both FIGS. 1 and 3, FIG. 3 is a flowchart of another operation method according to FIG. 1. In this embodiment, steps S110 to S140 have been described in the embodiments of FIGS. 1 and 2. Therefore, the same details will not be repeated in the following. A difference is that when the current value of the driving current ID is determined to be not in the target driving current value range RT in step S140, the controller 140 further determines whether the current value of the driving current ID is greater than the maximum value of the target driving current value range RT in step S250. When the current value of the driving current ID is determined to be greater than the maximum value of the target driving current value range RT, the controller 140 reduces the first control parameter PC1 in step S260. On the other hand, when the current value of the driving current ID is determined to be not greater than the maximum value of the target driving current value range RT, it indicates that the current value of the driving current ID is less than the minimum value of the target driving current value range RT. Therefore, the controller 140 increases the first control parameter PC1 in step S270.

Specifically, the controller 140 performs multiplication on the current calibration parameter PCC and the first control parameter PC1 to generate the control signal SC. In this embodiment, the current calibration parameter PCC is a preset value. During the normal use, the first control parameter PC1 is a value that is changed based on the current value of the driving current ID. A product of the current calibration parameter PCC and the first control parameter PC1 is, for example, proportional to the duty cycle of the control signal SC. The current value of the driving current ID is proportional to the duty cycle of the control signal SC. In other words, during the normal use, the controller 140 may adjust the first control parameter PC1 according to an actual result of the current value of the driving current ID, thereby calibrating the current value of the driving current ID.

For example, the current calibration parameter PCC and the first control parameter PC1 are percentage values respectively. The current calibration parameter PCC is preset as 96.8%, for example (the disclosure is not limited thereto). When the current value of the driving current ID is determined to be greater than the maximum value (such as 3.838 amperes) of the target driving current value range RT (such as 3.8 amperes ±1%, the disclosure is not limited thereto), the controller 140 reduces the first control parameter PC1 in step S260. Therefore, the duty cycle of the control signal SC decreases. The current value of the driving current ID falls to be in the target driving current value range RT. On the other hand, when the current value of the driving current ID is determined to be less than the minimum value (such as 3.762 amperes) of the target driving current value range RT, the controller 140 increases the first control parameter PC1 in step S270. Therefore, the duty cycle of the control signal SC increases. The current value of the driving current ID rises to be in the target driving current value rang RT.

When the current value of the driving current ID is determined to be in the target driving current value range RT in step S140, the controller 140 does not change the first control parameter PC1 in step S280. Therefore, the control signal SC is unchanged. The current value of the driving current ID is kept in the target driving current value range RT.

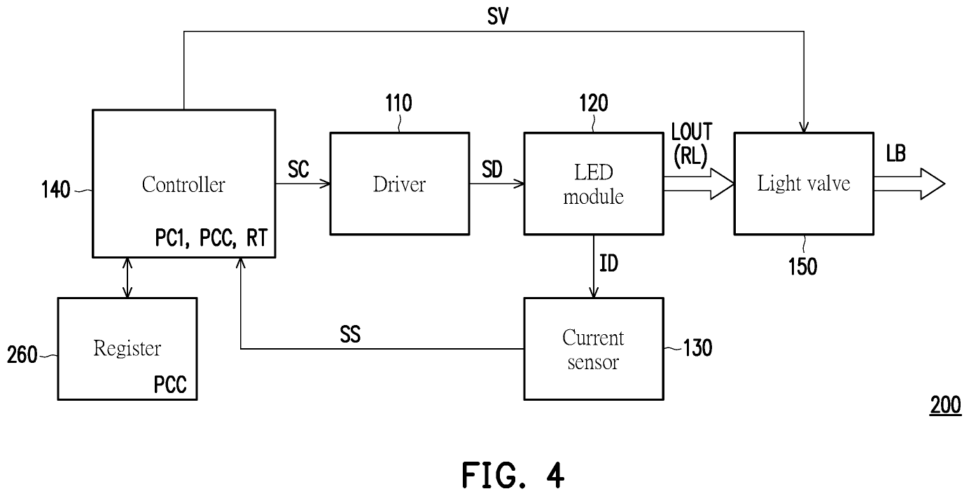

Referring to FIG. 4, FIG. 4 is a schematic view of a projection device according to the second embodiment of the disclosure. In this embodiment, a projection device 200 includes the driver 110, the LED module 120, the current sensor 130, the controller 140, the light valve 150, and a register 260. Implementation details of the driver 110, the LED module 120, the current sensor 130, the controller 140, and the light valve 150 have been clearly described in the embodiments shown in FIGS. 1 to 3. Therefore, the same details will not be repeated in the following. In this embodiment, the register 260 is coupled to the controller 140. The register 260 stores the current calibration parameter PCC from the controller 140. For example, during an initial setting period of the projection device 200, the controller 140 defines the current calibration parameter PCC. The initial setting period may be a setting period when the projection device 200 is turned on for the first time or a setting period before leaving the factory. The controller 140 stores the current calibration parameter PCC in the register 260 after defining the current calibration parameter PCC during the initial setting period. For example, the projection device 200 reads the current calibration parameter PCC stored in the register 260 when turned on. In this way, the controller 140 only defines the current calibration parameter PCC during the initial setting period. The operation overhead on the controller 140 may be reduced. The register 260 may be any type of memory circuit. In other embodiments, the register 260 may also be integrated into the controller 140, and the disclosure is not limited thereto.

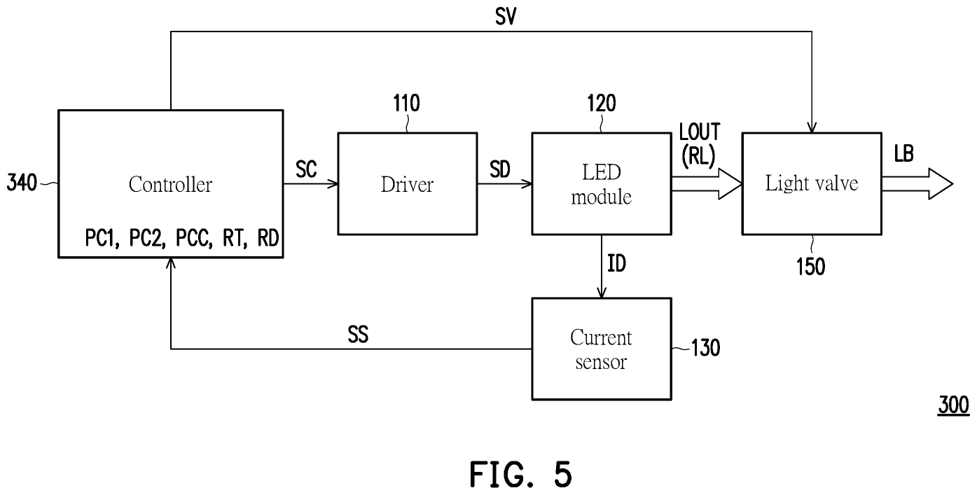

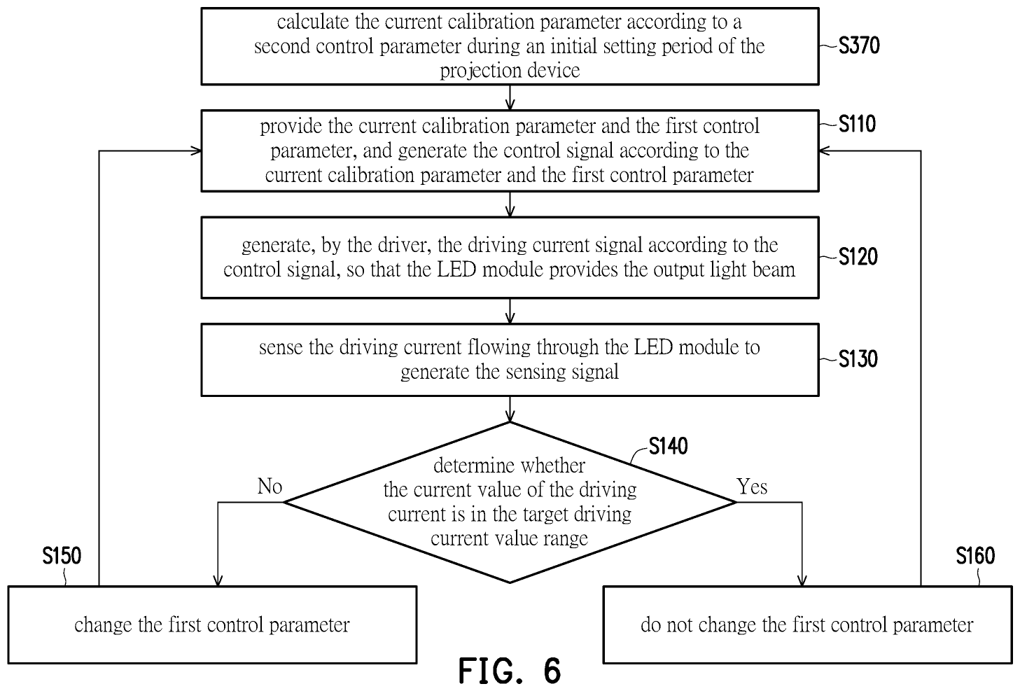

Referring to both FIGS. 5 and 6, FIG. 5 is a schematic view of a projection device according to the third embodiment of the disclosure. FIG. 6 is a flowchart of an operation method according to FIG. 5. The operation method in FIG. 6 is applicable to a projection device 300. In this embodiment, the projection device 300 includes the driver 110, the LED module 120, the current sensor 130, a controller 340, and a light valve 150. The implementation details of the driver 110, the LED module 120, the current sensor 130, and the light valve 150 have been clearly described in the embodiments shown in FIGS. 1 to 3. Therefore, the same details will not be repeated in the following. The operation method in this embodiment includes step S370 and steps S110 to S160. In this embodiment, for example, it is an initial setting of the projection device. A difference from the controller 140 shown in FIG. 1 is that in step S370, the controller 340 further calculates the current calibration parameter PCC according to a second control parameter PC2 during an initial setting period of the projection device 300. The controller 340 then performs the operation of step S110. Implementations of steps S110 to S160 have been clearly described in the embodiments shown in FIGS. 1 to 3. Therefore, the same details will not be repeated in the following.

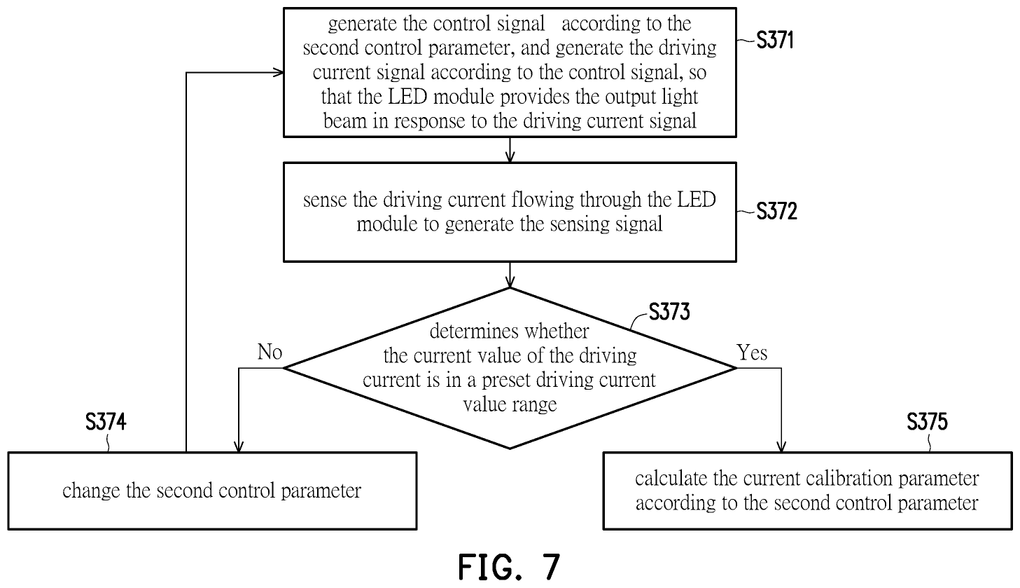

Next, an example is used to illustrate implementation details of step S370. Referring to FIGS. 5, 6, and 7 together, FIG. 7 is a flowchart according to step S370. In this embodiment, step S370 includes steps S371 to S375. Steps S371 to S375 are steps suitable for the initial setting period. In step S371, the controller 340 generates the control signal SC according to the second control parameter PC2. The driver 110 generates the driving current signal SD according to the control signal SC. The second control parameter PC2 is a value associated with the duty cycle of the control signal SC. Therefore, the LED module 120 provides the output light beam LOUT in response to the driving current signal SD. In step S372, the current sensor 130 senses the driving current ID flowing through the LED module 120 to generate the sensing signal SS. In step S373, the controller 340 receives the sensing signal SS. The controller 340 determines whether the current value of the driving current ID is in a preset driving current value range RD according to the sensing signal SS. When the current value of the driving current is not in the preset driving current value range RD, the controller 340 changes the second control parameter PC2 in step S374, and performs step S371 with the changed second control parameter PC2. On the other hand, when the current value of the driving current ID is determined to be in the preset driving current value range RD, the controller 340 calculates the current calibration parameter PCC according to the second control parameter PC2 in step S375, and thus proceeds to step S110.

For example, the preset driving current value range RD is set as 3.8 amperes ±1% (i.e., 3.762 amperes to 3.838 amperes). During the initial setting period, the controller 340 generates the driving current signal SD with an initial value (e.g., “992”) of the second control parameter PC2 (e.g., a factory preset value of the projection device 300). In an ideal situation, when the value of the second control parameter PC2 is equal to “992”, the current value of the driving current ID is equal to 3.8 amperes. However, in the actual operation during the initial setting period, when the value of the second control parameter PC2 is equal to “992”, the current value of the driving current ID is outside the preset driving current value range RD. The controller 340 changes the value of the second control parameter PC2 from “992” to “990” in step S374. Therefore, the duty cycle of the control signal SC is adjusted, so that the current value of the driving current ID is controlled in the preset driving current value range RD. When the current value of the driving current ID is determined to be in the preset driving current value range RD, the controller 340 calculates the current calibration parameter PCC based on the value of “990” in step S375. For example, the current calibration parameter PCC is calculated by a quotient of dividing the present value of the second control parameter PC2 by a maximum value (the maximum value of the control parameter) of the second control parameter PC2. For example, the maximum value of the second control parameter PC2 is “1023”. Therefore, the current calibration parameter PCC is 96.8% (i.e., 990÷1023×100%).

In this embodiment, the preset driving current value range RD may be the same as the target driving current value range RT. In some embodiments, the preset driving current value range RD may be different from the target driving current value range RT.

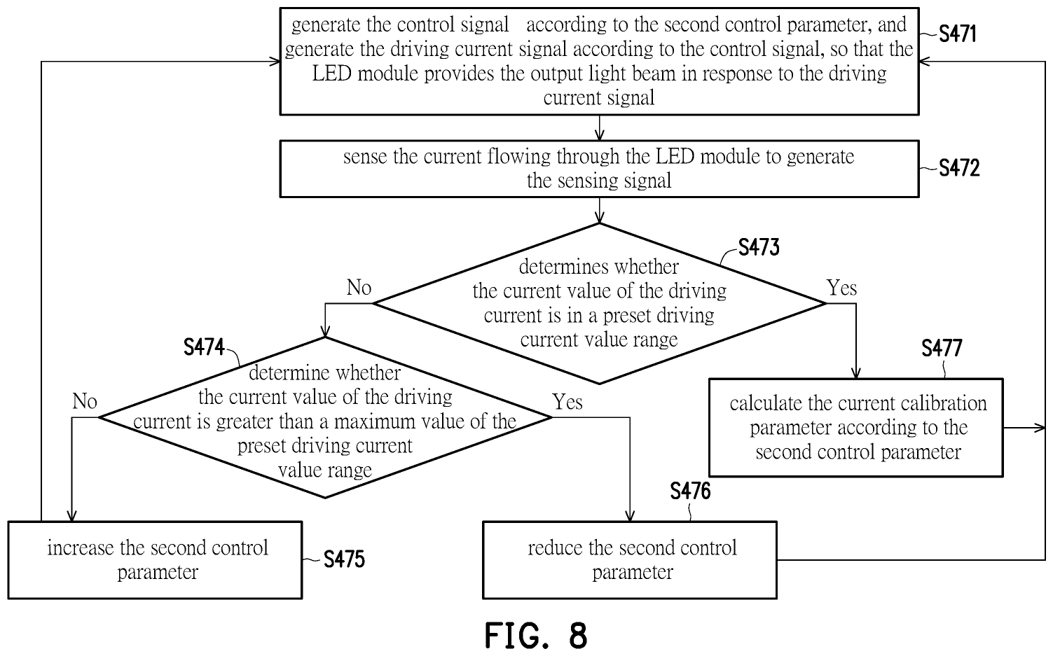

Referring to FIGS. 5, 6, and 8 together, FIG. 8 is another flowchart according to step S370. In this embodiment, step S370 includes steps S471 to S477. Steps S471 to S477 are also steps suitable for the initial setting period. Implementations of steps S471 to S473 are the same as steps S371 to S373 shown in FIG. 7. Therefore, the same details will not be repeated in the following. A difference is that during the initial setting period, when the current value of the driving current ID is determined to be not in the preset driving current value range RD in step S473, the controller 340 further determines whether the current value of the driving current ID is greater than a maximum value of the preset driving current value range RD in step S474. When the current value of the driving current ID is determined to be greater than the maximum value of the preset driving current value range RD, the controller 340 reduces the second control parameter PC2 in step S476. On the other hand, when the current value of the driving current ID is determined to be not greater than the maximum value of the preset driving current value range RD, it indicates that the current value of the driving current ID is less than the minimum value of the preset driving current value range RD. Therefore, the controller 340 increases the second control parameter PC2 in step S475.

When the current value of the driving current ID is determined to be in the preset driving current value range RD in step S473, the controller 140 calculates the current calibration parameter PCC according to the second control parameter PC2 in step S477.

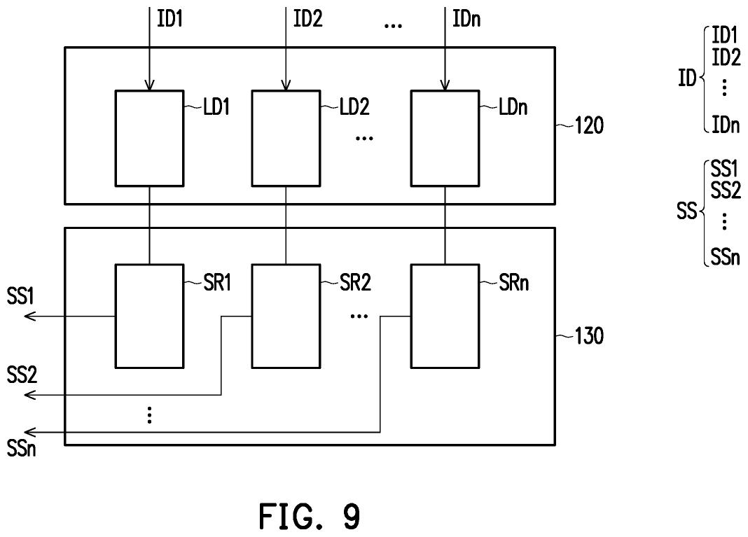

Referring to FIGS. 1 and 9, FIG. 9 is a schematic view of a LED module and a current sensor according to an embodiment of the disclosure. In this embodiment, the LED module 120 includes LEDs LD1 to LDn. The driving current ID includes sub-driving currents ID1 to IDn. The LEDs LD1 to LDn provide output light beams of different colors (or color temperatures) in response to a current value of the corresponding sub-driving current among the sub-driving currents respectively. For example, the LED LD1 provides an output light beam of a first color in response to a current value of the sub-driving current ID1. The LED LD2 provides an output light beam of a second color in response to a current value of the sub-driving current ID2, and the rest may be derived by analog. Therefore, the LED module 120 adjusts a target color of the output light beam LOUT based on the sub-driving currents ID1 to IDn.

The current sensor 130 senses the sub-driving currents ID1 to IDn flowing through the LEDs LD1 to LDn to generate sensing values SS1 to SSn corresponding to the sub-driving currents ID1 to IDn in the sensing signal SS. For example, the current sensor 130 includes sensing elements SR1 to SRn. The sensing element SR1 senses the current value of the sub-driving current ID1 flowing through the LED LD1 to generate the sensing value SS1. The sensing element SR2 senses a current value of the sub-driving current ID2 flowing through the LED LD2 to generate the sensing value SS2, and the rest may be derived by analog. In this embodiment, the sensing elements SR1 to SRn may be implemented by resistors with the same design respectively.

In this embodiment, as in steps S140, S150, and S160, the controller 140 may determine whether to change the first control parameter PC1 respectively corresponding to the LEDs LD1 to LDn according to the sensing values SS1 to SSn. Since a brightness of the LEDs LD1 to LDn of different colors is adjusted in this embodiment, the target color of the output light beam LOUT may be precisely adjusted. In this way, when projection images of the projection devices 100 are stitched together, a color difference of a stitching result of the projection images may be reduced.

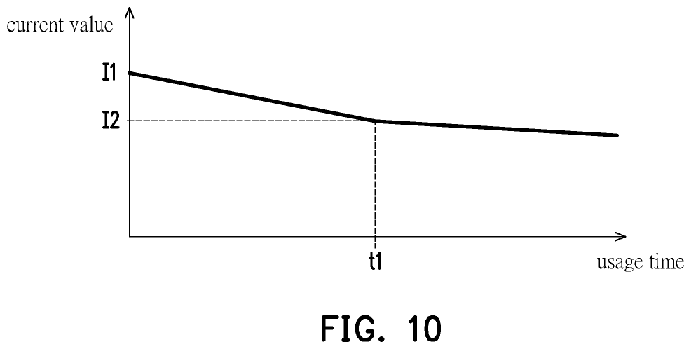

Referring to both FIGS. 1 and 10, FIG. 10 is a tendency chart of a current value of a driving current according to an embodiment of the disclosure. In this embodiment, during the normal use, the controller 140 may further determine a current value decreasing amount of the current value of the driving current ID in a preset time length according to the sensing signal SS, and reduce the first control parameter PC1 according to the current value drop. For example, after the projection device 100 is enabled, the controller 140 starts timing the running time and uses the sensing signal SS to monitor the current value of the driving current ID. When the running time reaches the preset time length, the controller 140 confirms the current value decreasing amount at a time point t1, that is, a decreasing amount between current values I1 and I2. When the current value decreasing amount is greater than a preset threshold, it indicates that an electrical property of the LED module 120 has seriously deteriorated. Therefore, the controller 140 reduces the first control parameter PC1 and maintains the current value of the driving current ID in the target driving current value range RT. The subsequent current value decreasing amount is reduced. In this way, the service life of the LED module 120 may be extended.

Based on the above, the embodiments of the disclosure have at least one of the following advantages or effects. When the current value of the driving current is not in the target driving current value range, the projection device may change the first control parameter to adjust the control signal. Different from the existing calibration method, in the disclosure, the first control parameter is used to adjust the control signal instead of adjusting the resistance value of the current limiting resistor. In this way, in the disclosure, the high-precision calibration is performed on the operation of the LED module of the projection device.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection device, comprising:
a driver configured to generate a driving current signal according to a control signal;
a LED module coupled to the driver and configured to provide an output light beam in a target brightness value range in response to the driving current signal, wherein the target brightness value range corresponds to a target driving current value range of the driving current signal;
a current sensor coupled to the LED module and configured to sense a driving current flowing through the LED module to generate a sensing signal; and
a controller coupled to the current sensor and the driver and configured to provide a current calibration parameter and a first control parameter, generate the control signal according to the current calibration parameter and the first control parameter, and determine whether a current value of the driving current flowing through the LED module is in the target driving current value range according to the sensing signal,
wherein when the current value of the driving current is not in the target driving current value range, the controller changes the first control parameter to adjust the control signal.

2. The projection device according to claim 1, further comprising:
a light valve coupled to the controller,
wherein the controller controls the light valve to convert the output light beam to generate an image light beam.

3. The projection device according to claim 1, wherein the controller performs multiplication on the current calibration parameter and the first control parameter to generate the control signal.

4. The projection device according to claim 1, wherein the controller samples the sensing signal based on a sampling cycle.

5. The projection device according to claim 1, wherein
when the current value of the driving current is determined to be greater than a maximum value of the target driving current value range, the controller reduces the first control parameter, and
when the current value of the driving current is determined to be less than a minimum value of the target driving current value range, the controller increases the first control parameter.

6. The projection device according to claim 1, wherein the controller determines a current value decreasing amount of the current value of the driving current in a preset time length according to the sensing signal, and reduces the first control parameter according to the current value decreasing amount.

7. The projection device according to claim 1, wherein
the LED module comprises a plurality of LEDs,
the driving current comprises a plurality of sub-driving currents,
the LEDs provide output light beams of different colors in response to a current value of the corresponding sub-driving current among the sub-driving currents respectively,
the current sensor senses the sub-driving currents flowing through the LEDs to generate a plurality of sensing values corresponding to the sub-driving currents in the sensing signal.

8. The projection device according to claim 1, wherein
during an initial setting period of the projection device, the controller calculates the current calibration parameter according to a second control parameter,
during the initial setting period, the controller generates the control signal according to the second control parameter, and the driver generates the driving current signal according to the control signal, and
the second control parameter is a value associated with a duty cycle of the control signal.

9. The projection device according to claim 8, wherein during the initial setting period,
the controller receives the sensing signal, and determines whether the current value of the driving current flowing through the LED module is in a preset driving current value range according to the sensing signal, and
when the current value of the driving current is not in the preset driving current value range, the controller changes the second control parameter.

10. The projection device according to claim 8, wherein
when the current value of the driving current is determined to be greater than a maximum value of the preset driving current value range, the controller reduces the second control parameter,
when the current value of the driving current is determined to be less than a minimum value of the preset driving current value range, the controller increases the second control parameter.

11. The projection device according to claim 8, wherein when the current value of the driving current is determined to be in the preset driving current value range, the controller calculates the current calibration parameter according to the second control parameter.

12. The projection device according to claim 8, further comprising:
a register coupled to the controller and configured to store the current calibration parameter from the controller.

13. An operation method of a projection device, wherein the projection device comprises a driver and an LED module, and the operation method comprises:
providing a current calibration parameter and a first control parameter, and generating a control signal according to the current calibration parameter and the first control parameter;
generating, by the driver, a driving current signal according to the control signal, so that the LED module provides an output light beam in a target brightness value range in response to the driving current signal, wherein the target brightness value range corresponds to a target driving current value range of the driving current signal;
sensing a driving current flowing through the LED module to generate a sensing signal;
determining whether a current value of the driving current flowing through the LED module is in the target driving current value range according to the sensing signal, and
when the current value of the driving current is not in the target driving current value range, changing the first control parameter to adjust the control signal.

14. The operation method according to claim 13, wherein
controlling a light valve to convert the output light beam to generate an image light beam.

15. The operation method according to claim 13, wherein generating the control signal according to the current calibration parameter and the first control parameter comprises:
performing multiplication on the current calibration parameter and the first control parameter to generate a driving signal, and generating the driving current signal according to the driving signal.

16. The operation method according to claim 13, wherein sampling the sensing signal comprises:
sampling the sensing signal based on a sampling cycle.

17. The operation method according to claim 13, wherein changing the first control parameter when the current value of the driving current is not in the target driving current value range comprises:
when the current value of the driving current is determined to be greater than a maximum value of the target driving current value range, reducing the first control parameter, and
when the current value of the driving current is determined to be less than a minimum value of the target driving current value range, increasing the first control parameter.

18. The operation method according to claim 13, further comprising:
determining a current value decreasing amount of the current value of the driving current in a preset time length according to the sensing signal; and
reducing the first control parameter according to the current value decreasing amount.

19. The operation method according to claim 13, further comprising:
during an initial setting period of the projection device, calculating the current calibration parameter according to a second control parameter.

20. The operation method according to claim 19, further comprising:
during the initial setting period, generating the control signal according to the second control parameter, and generating the driving current signal according to the control signal, so that the LED module provides the output light beam in response to the driving current signal, wherein
the second control parameter is a value associated with a duty cycle of the control signal.

21. The operation method according to claim 19, wherein calculating the current calibration parameter according to the second control parameter during the initial setting period of the projection device comprises:
receiving the sensing signal, and determining whether the current value of the driving current flowing through the LED module is in a preset driving current value range according to the sensing signal, and
when the current value of the driving current is not in the preset driving current value range, changing the second control parameter.

22. The operation method according to claim 19, wherein changing the second control parameter when the current value of the driving current is not in the preset driving current value range comprises:
when the current value of the driving current is determined to be greater than a maximum value of the preset driving current value range, reducing the second control parameter, and
when the current value of the driving current is determined to be less than a minimum value of the preset driving current value range, increasing the second control parameter.

23. The operation method according to claim 19, wherein calculating the current calibration parameter according to the second control parameter during the initial setting period of the projection device comprises:
when the current value of the driving current is determined to be in the preset driving current value range, calculating the current calibration parameter according to the second control parameter.
